(19) United States
(12) Patent Application Publication
(10) Pub. No.: US 2024/0429652 A1
(43) Pub. Date: Dec. 26, 2024

(54) CONNECTOR

(71) Applicant: YAZAKI CORPORATION, Tokyo (JP)

(72) Inventors: Hideto Kumakura, Makinohara-shi (JP); Yuuki Hiruta, Fujieda-shi (JP)

(21) Appl. No.: 18/677,826

(22) Filed: May 29, 2024

(30) Foreign Application Priority Data
Jun. 26, 2023 (JP) 2023-103895

(51) Int. Cl. H01R 13/621; H01R 13/629; H01R 13/6581

(52) U.S. Cl. CPC H01R 13/621; H01R 13/629; H01R 13/6581

(57) ABSTRACT

A connector includes a housing member having a fitting portion to be fitted with a mating connector, and a fixing member fixed to a fixed wall surface together with the housing member. The fixing member has the through hole of the fastening bolt that is fastened to the fastening hole of the fixed wall surface to fix the fixing member to the fixed wall surface together with the housing member. The housing member is positioned on the opposite side of the through hole provided in the fixing member with the fitting portion interposed therebetween with respect to the vertical direction, and has the positioning projection portion formed to protrude toward the fixed wall surface in the fitted state. The positioning projection portion is inserted into the wall surface groove portion formed in the fixed wall surface along the insertion and removal direction in the fitted state.

### CROSS-REFERENCE TO RELATED APPLICATION(S)

The present application claims priority to and incorporates by reference the entire contents of Japanese Patent Application No. 2023-103895 filed in Japan on Jun. 26, 2023.

### BACKGROUND OF THE INVENTION

### 1. Field of the Invention

The present invention relates to a connector.

### 2. Description of the Related Art

Devices such as an inverter and a motor mounted on an electric vehicle and a hybrid vehicle are connected to each other by a connector attached to an end of an electric wire. The connector is electrically connected to a counterpart equipment by being fitted to a mating connector provided in the counterpart equipment.

For example, Japanese Patent Application Laid-open No. 2020-102307 discloses a connector that includes a fitting portion that accommodates a terminal and is fitted to a mating connector provided on a connection target, and a shield shell that accommodates the fitting portion, and fixes the shield shell and a fixed wall surface of the connection target with a fastening bolt in a fitted state in which the fitting portion is fitted to the mating connector.

In the connector disclosed in Japanese Patent Application Laid-open No. 2020-102307, for example, when the shield shell and the fixed wall surface of the connection target are fixed with the fastening bolt, if the connector is inclined with respect to the mating connector, the terminal in the fitting portion may be twisted with respect to the mating connector, and thus there is room for improvement.

### SUMMARY OF THE INVENTION

An object of the present invention is to provide a connector that can be appropriately fitted to a mating connector.

In order to achieve the above mentioned object, a connector according to one aspect of the present invention includes a housing member that accommodates a terminal and has a fitting portion to be fitted with a mating connector provided on a connection target; and a fixing member fixed to a fixed wall surface of the connection target together with the housing member in a fitted state in which the fitting portion is fitted to the mating connector, wherein the fixing member includes a through hole through which a fastening bolt communicating with a fastening hole formed in the fixed wall surface along a fitting direction of the fitting portion with respect to the mating connector in the fitted state and fastened to the fastening hole is inserted into the fixing member along the fitting direction, one of the housing member and the fixing member includes a positioning projection portion positioned on an opposite side of the through hole across the fitting portion with respect to an intersecting direction intersecting the fitting direction and formed to project toward a side of the fixed wall surface in the fitted state, and the positioning projection portion is inserted into a groove portion formed in the fixed wall surface along the fitting direction in the fitted state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a connector according to an embodiment;

FIG. 2 is a perspective view illustrating a schematic configuration of the connector according to the embodiment;

FIG. 3 is a front view of the connector according to the embodiment as viewed from a fitting direction;

FIG. 4 is an exploded perspective view illustrating a schematic configuration of the connector according to the embodiment;

FIG. 5 is a cross-sectional view illustrating when the connector is fitted according to the embodiment;

FIG. 6 is a cross-sectional view illustrating a fitting operation of the connector according to the embodiment; and

FIG. 7 is a cross-sectional view illustrating a fitting operation of the connector according to the embodiment.

### DETAILED DESCRIPTION OF THE PREFERRED EMBODIMENTS

Hereinafter, an embodiment according to the present invention will be described in detail with reference to the drawings. Note that the present invention is not limited by this embodiment. In addition, components in the following embodiment include those that can be easily replaced by those skilled in the art or those that are substantially the same.

### Embodiment

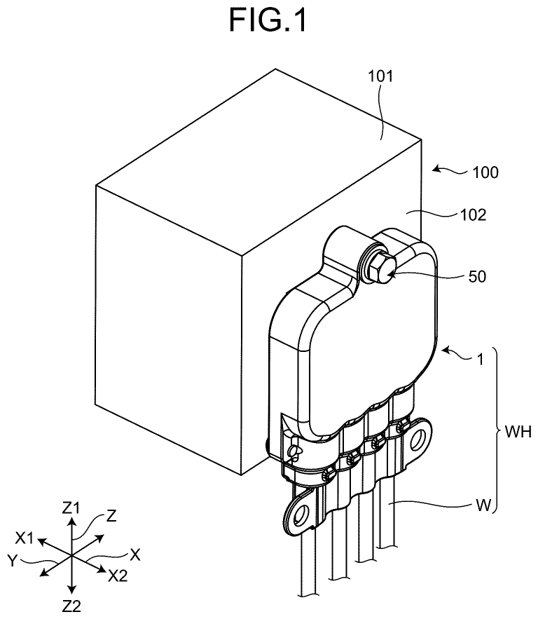

A connector 1 according to the present embodiment illustrated in FIGS. 1, 2, and 3 is incorporated in, for example, a wire harness WH routed in a vehicle such as an automobile. For example, the wire harness WH is configured such that a plurality of wiring members W used for power supply and signal communication are bundled to form a collective component for connection between devices mounted on a vehicle, and the plurality of wiring members W are connected to the devices by the connector 1 or the like. The wire harness WH includes the wiring members W having conductivity and the connector 1 electrically connected to the wiring members W.

The wiring member W includes, for example, an electric wire in which an outer side of a conductor portion (core wire) including a plurality of conductive metal wires is covered with an insulating covering portion, an electric wire bundle obtained by bundling the electric wires, a metal rod in which an outer side of a conductive bar-shaped member is covered with the insulating covering portion, and the like. The wire harness WH may further include a grommet, a protector, a fixture, an electrical junction box, and the like.

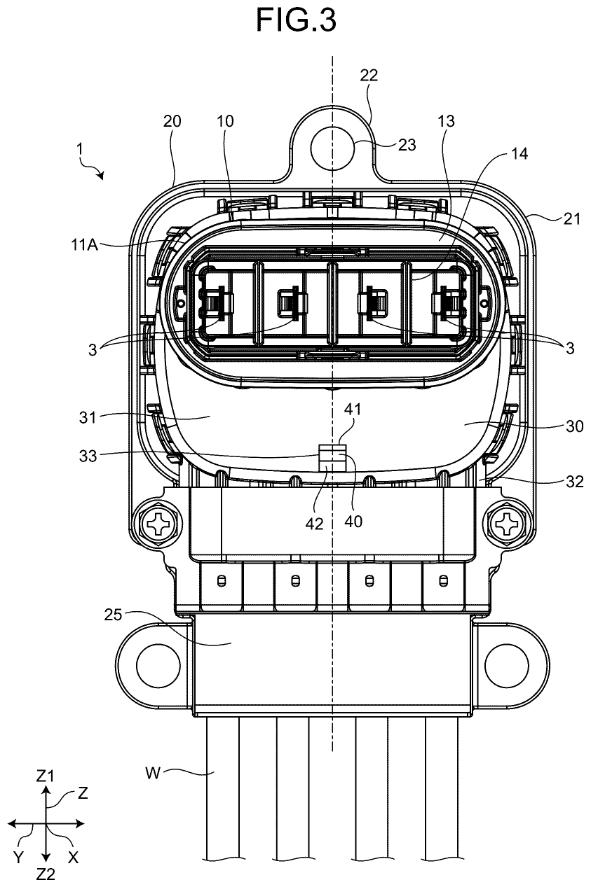

The connector 1 of the present embodiment is physically and electrically connected to a mating device 100 to be connected. The connector 1 is inserted into a connector insertion hole 103 formed in a housing 101 of the mating device 100 to be fitted to a mating connector 110 to form an electrical connection portion with the mating device 100. The connector 1 is fixed to a fixed wall surface 102 of the mating device 100 in a state where the connector 1 is fitted to the mating connector 110. As illustrated in FIG. 3, the connector 1 in the present embodiment includes a housing member 10 having a fitting portion 11A to be fitted to the mating connector 110, and a fixing member 20 fixed to the fixed wall surface 102. Here, a state in which the connector 1 is fitted to the mating connector 110 is a state in which a fitting portion 11A is fitted to the mating connector 110 and the fixing member 20 is fixed to the fixed wall surface 102. In the present embodiment, the connector 1 will be described as a male connector, and the mating connector 110 will be described as a female connector.

In the following description, among an X direction, a Y direction, and a Z direction in the drawing, the X direction is referred to as an “insertion and removal direction X”, the Y direction is referred to as a “width direction Y”, and the Z direction is referred to as a “vertical direction Z”. The insertion and removal direction X, the width direction Y, and the vertical direction Z are orthogonal to each other. In the present embodiment, in the insertion and removal direction X, an X1 direction is referred to as an “insertion direction X1”, and an X2 direction is referred to as a “removal direction X2”. The insertion direction X1 is a direction along a fitting direction of the connector 1 with respect to the mating connector 110. In the vertical direction Z, a Z1 direction is referred to as an “upward direction Z1”, and a Z2 direction is referred to as a “downward direction Z2”. In the present embodiment, the vertical direction Z is a direction along the vertical direction, but the present invention is not limited thereto.

The fixed wall surface 102 is a wall surface of the housing 101 on the removal direction X2 side of the housing 101, and is a portion to which the connector 1 is attached and fixed. The fixed wall surface 102 is formed of a uniform flat surface, and is provided with a plurality of holes. Specifically, the fixed wall surface 102 is provided with a connector insertion hole 103, a fastening hole 104, a wall surface groove portion 105, and a pair of groove portions 106. The connector insertion hole 103, the fastening hole 104, the wall surface groove portion 105, and the pair of groove portions 106 are all formed in a substantially linear shape from the fixed wall surface 102 along the insertion and removal direction X. Among the connector insertion hole 103, the fastening hole 104, the wall surface groove portion 105, and the pair of groove portions 106, the connector insertion hole 103, the fastening hole 104, and the wall surface groove portion 105 are linearly arranged along the vertical direction Z. These three holes (or grooves) are arranged in the order of the fastening hole 104, the connector insertion hole 103, and the wall surface groove portion 105 from the upward direction Z1 toward the downward direction Z2.

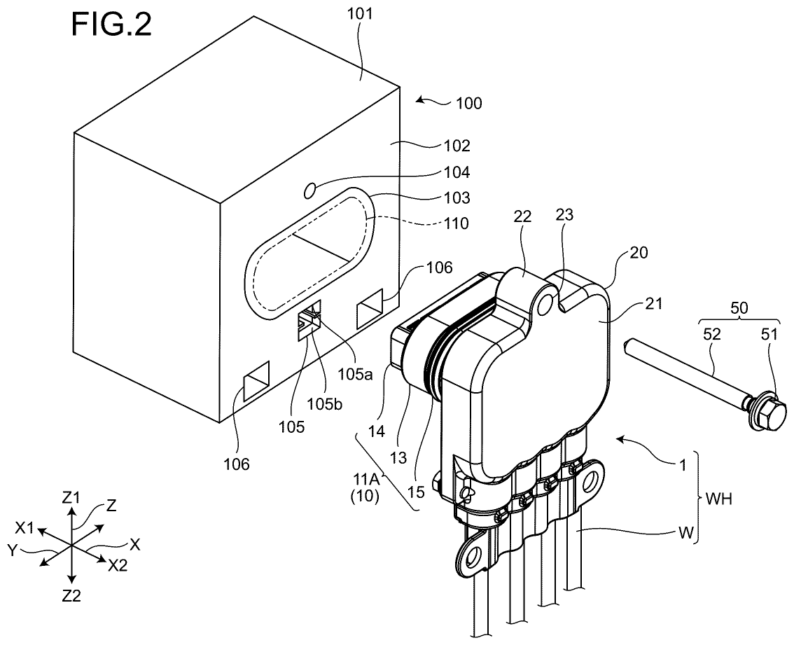

As illustrated in FIGS. 2 and 5 to 7, in the connector insertion hole 103, the mating connector 110 is accommodated inside the connector insertion hole 103, and the fitting portion 11A is inserted in a state where the connector 1 is fitted to the mating connector 110. An opening shape of the connector insertion hole 103 is formed in accordance with the shape of the fitting portion 11A of the connector 1 as viewed from the insertion direction X1. For example, an opening shape of the connector insertion hole 103 viewed from the insertion direction X1 is formed in a substantially elliptical shape. The connector insertion hole 103 is positioned between the fastening hole 104 and the wall surface groove portion 105 among the fastening hole 104, the connector insertion hole 103, and the wall surface groove portion 105 arranged along the vertical direction Z.

The fastening hole 104 is a portion to which a fastening bolt 50 for fixing the connector 1 to the fixed wall surface 102 is screwed in a state where the connector 1 is fitted to the mating connector 110. The fastening bolt 50 includes a head portion 51 and a shaft portion 52. The fastening hole 104 is a hole in which a screw groove is formed in the inner peripheral surface, and a shaft portion 52 of the fastening bolt 50 is screwed. The fastening hole 104 is located on the upward direction Z1 side of the connector insertion hole 103.

The fastening bolt 50 is a fastening member that fixes the connector 1 to the fixed wall surface 102. The head portion 51 is provided at one end in an extending direction of the shaft portion 52 and is a portion serving as a base portion of the fastening bolt 50. The head portion 51 has a hexagonal shape as viewed from the extending direction of the shaft portion 52. The shaft portion 52 is formed in a columnar shape. On a surface of the shaft portion 52, a spiral screw groove is formed along the extending direction of the shaft portion 52. As illustrated in FIG. 2, the fastening bolt 50 is inserted into a through hole 23 provided in the fixing member 20 along the insertion and removal direction X. The fastening bolt 50 is fastened to the fastening hole 104 by being screwed into the fastening hole 104 while being inserted into the through hole 23. That is, as illustrated in FIG. 2, the connector 1 is fixed to the fixed wall surface 102 by the fastening bolt 50 in a state where the fixing member 20 is attached so as to cover the housing member 10. With such a configuration, the fixing member 20 is fixed to the fixed wall surface 102 together with a housing member 10 in a fitted state in which the fitting portion 11A is fitted to the mating connector 110.

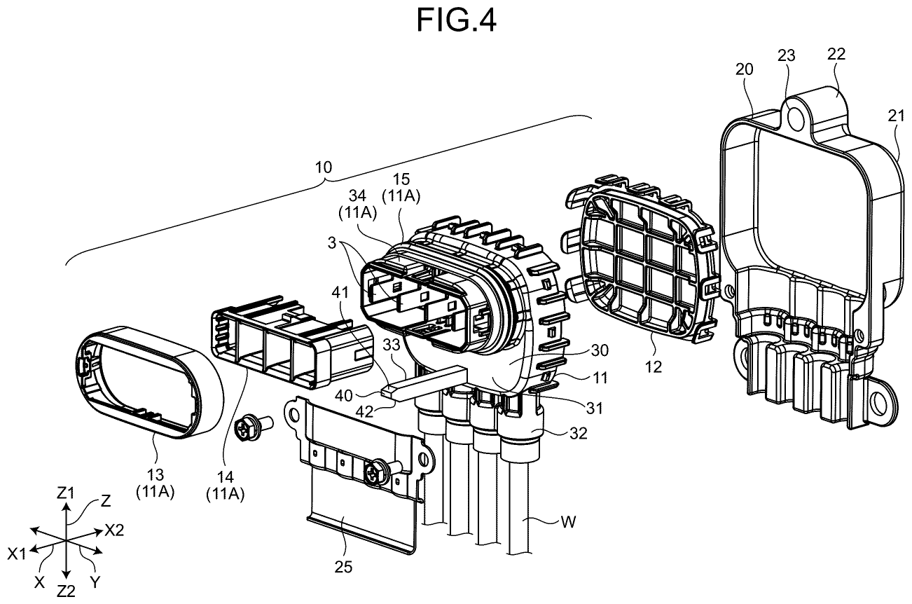

The wall surface groove portion 105 is a portion into which a positioning projection portion 33 provided on the connector 1 side illustrated in FIGS. 3 and 4 is inserted in a fitted state in which the fitting portion 11A is fitted to the mating connector 110. An opening shape of the wall surface groove portion 105 is formed, for example, in accordance with a shape viewed from the insertion direction X1 of the positioning projection portion 33. The wall surface groove portion 105 of the present embodiment is formed to have a rectangular opening shape. The wall surface groove portion 105 is located on the downward direction Z2 side of the connector insertion hole 103. As illustrated in FIGS. 2 and 5 to 7, the wall surface groove portion 105 has a pair of first guide surface 105a and second guide surface 105b.

The pair of first guide surface 105a and second guide surface 105b are provided in the vertical direction Z with the opening interposed therebetween. The first guide surface 105a and the second guide surface 105b are inclined inward of the wall surface groove portion 105 from the fixed wall surface 102 toward the insertion direction X1.

The pair of groove portions 106 is portions that accommodate bolt heads provided on the connector 1 side in a fitted state in which the fitting portion 11A is fitted to the mating connector 110. The pair of groove portions 106 is disposed at regular intervals along the width direction Y so as to sandwich the wall surface groove portion 105.

The housing member 10 has a fitting portion 11A that houses connector terminals 3 and is fitted to the mating connector 110. As illustrated in FIG. 4, the housing member 10 includes a plurality of parts. Specifically, the housing member 10 includes a housing 11, a rear cover 12, a front holder 13, an inner housing 14, and a seal packing 15. Each of the housing 11, the rear cover 12, the front holder 13, and an inner housing 14 is made of an insulating resin material. The fitting portion 11A of the present embodiment includes a cylindrical portion 34 provided in the housing 11, a front holder 13 assembled to the cylindrical portion 34, an inner housing 14, and a seal packing 15.

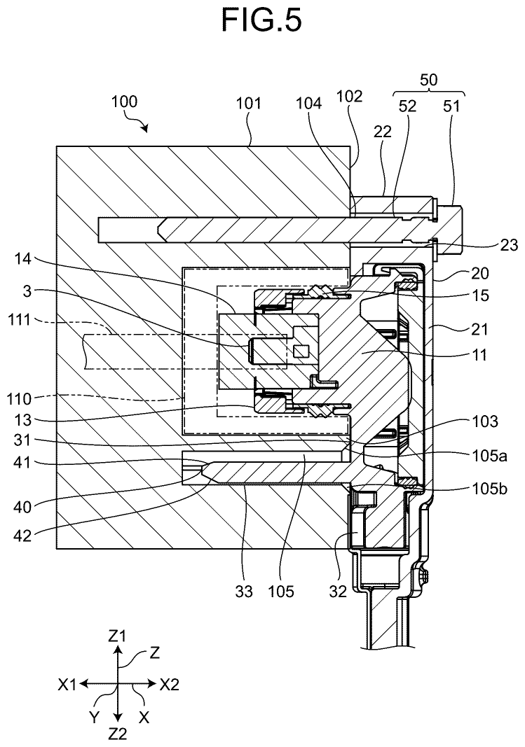

The housing 11 and a rear cover 12 are members that are assembled to each other to form a box shape and accommodate four connector terminals 3. The connector terminal 3 is a metal fitting made of a conductive metal material. As illustrated in FIG. 5, the connector terminal 3 is a male terminal electrically connected to a female mating terminal 111. The connector terminals 3 are physically and electrically connected to the terminals of the wiring members W. Note that the housing 11 and the rear cover 12 house the four connector terminals 3 in a state of being combined with each other, but are not limited thereto.

The housing 11 is formed with both ends in the insertion and removal direction X opened. In the housing 11, in a state where the connector terminals 3 are accommodated, the connector terminals 3 are exposed to the outside from the opening on the insertion direction X1 side, and the opening on the removal direction X2 side is closed by the rear cover 12. The housing 11 includes a housing body 30 and a wiring member insertion portion 32, which are integrally formed.

As illustrated in FIG. 3, the housing body 30 is formed in a substantially rectangular shape as viewed from the insertion direction X1. The housing body 30 has an opposing surface 31 facing the fixed wall surface 102 in the insertion and removal direction X and the cylindrical portion 34 protruding from the opposing surface 31 toward the mating connector 110 and accommodated inside the mating connector 110 in a fitted state in which the fitting portion 11A is fitted to the mating connector 110. As illustrated in FIGS. 3 to 7, the opposing surface 31 has the positioning projection portion 33 formed to protrude toward the fixed wall surface 102 in a fitted state in which the fitting portion 11A is fitted to the mating connector 110. In the cylindrical portion 34, the cylindrical inner housing 14 is accommodated along the inner peripheral surface, and the rear cover 12 is attached along the outer peripheral surface.

As illustrated in FIG. 3, the positioning projection portion 33 is located on the opposite side of the through hole 23 across the fitting portion 11A with respect to the vertical direction Z which is an intersecting direction intersecting the insertion direction X1. The positioning projection portion 33 has a rectangular cross-sectional shape as viewed in the insertion and removal direction X. The positioning projection portion 33 is inserted into the wall surface groove portion 105 in a fitted state in which the fitting portion 11A is fitted to the mating connector 110. The positioning projection portion 33 includes a distal end portion 40 provided at a distal end on the insertion direction X1 side, a first inclined surface 41 provided on the upward direction Z1 side from the distal end portion 40, and a second inclined surface 42 provided on the downward direction Z2 side from the distal end portion 40.

The distal end portion 40 is positioned between the first inclined surface 41 and the second inclined surface 42 in the vertical direction Z. The first inclined surface 41 is inclined from the distal end portion 40 in the upward direction Z1 along the removal direction X2. The second inclined surface 42 is an inclined surface inclined from the distal end portion 40 toward the downward direction Z2 along the removal direction X2. In a fitted state in which the fitting portion 11A is fitted to the mating connector 110 and in a state in which the connector 1 is fixed to the fixed wall surface 102 by the fastening bolt 50, the distal end portion 40 is located on the insertion direction X1 side with respect to the distal end on the insertion direction X1 side of the cylindrical portion 34 when viewed from the width direction Y, and is located on the removal direction X2 side with respect to the distal end on the insertion direction X1 side of the shaft portion 52.

The inner housing 14 is a member formed separately from the housing 11, and is a member that accommodates and holds the connector terminal 3 along the insertion and removal direction X in a state of being attached to the housing body 30.

The seal packing 15 is a water stop member formed in an annular shape and attached to the housing 11. The seal packing 15 is interposed between the housing 11 and the mating connector 110 in a fitted state in which the fitting portion 11A is fitted to the mating connector, and comes into contact with the housing 11 and the mating connector 110 to stop water and secure sealing performance.

The wiring member insertion portion 32 is a portion through which the wiring members W are inserted. The wiring member insertion portion 32 is formed so as to protrude along the downward direction 22 from an end portion on the downward direction Z2 side of the housing body 30. The wiring member insertion portion 32 is formed in a tubular shape, and the wiring members W are routed inside the wiring member insertion portion along the vertical direction Z. That is, the housing 11 holds the connector terminal 3 along the insertion and removal direction X, and the wiring members W are inserted along the vertical direction Z orthogonal to the insertion and removal direction X. Here, the four wiring members W are inserted into the wiring member insertion portion 32.

The fixing member 20 is fixed to the fixed wall surface 102 together with the housing member 10 in a fitted state in which the fitting portion 11A is fitted to the mating connector 110. As illustrated in FIG. 4, the fixing member 20 includes a shell body 21 and a lower shell 25. The shell body 21 and the lower shell 25 are each formed of a conductive metal material.

The shell body 21 is formed in a vat shape so as to cover the outer side of the housing 11, and a bracket portion 22 is provided at an end portion on the upward direction Z1 side. The shell body 21 is formed of a so-called shield shell and is formed to cover the outer side of the housing member 10. The bracket portion 22 has a through hole 23 through which the fastening bolt 50 is inserted along the insertion and removal direction X. The through hole 23 is a through hole penetrating along the insertion and removal direction X of the bracket portion 22, and the shaft portion 52 of the fastening bolt 50 is inserted therethrough. As described above, the shell body 21 can be referred to as a shield shell provided with the through hole 23.

The lower shell 25 is a portion that fixes the housing member 10 to the fixing member 20 by being fastened to the shell body 21 with a bolt or the like. The lower shell 25 is fixed to the shell body 21 by fastening two bolts in a state where the wiring member insertion portion 32 of the housing member 10 is sandwiched between the lower shell 25 and the shell body 21 in the insertion and removal direction X.

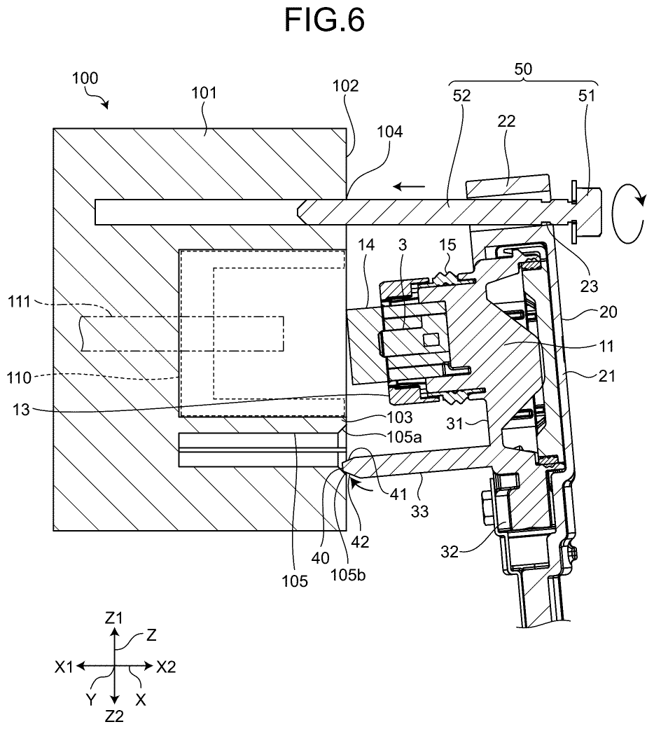

Next, a work operation of fitting the connector 1 having the above configuration to the mating connector 110 and fixing the connector 1 to the fixed wall surface 102 will be described. First, in a state where the fastening bolt 50 is inserted into the through hole 23 of the fixing member 20 of the connector 1, an operator inserts the fastening bolt 50 into the fastening hole 104 of the fixed wall surface 102 and screws the fastening bolt. At this time, as illustrated in FIG. 6, the end portion of the connector 1 on the upward direction Z1 side is relatively close to the fixed wall surface 102 with respect to the end portion on the downward direction Z2 side, and may not face the fixed wall surface 102.

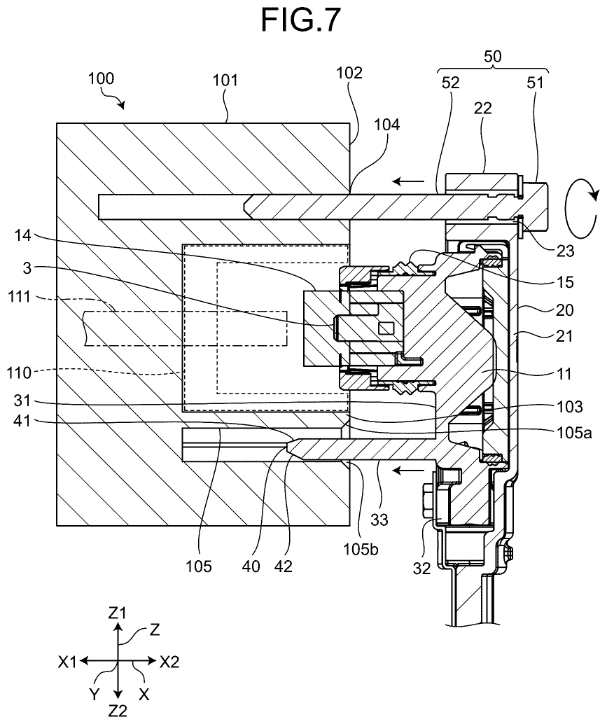

When the operator further screws the fastening bolt 50 into the fastening hole 104, the positioning projection portion 33 abuts on the wall surface groove portion 105 of the fixed wall surface 102. At this time, in the positioning projection portion 33, any one of the distal end portion 40, the second inclined surface 42, and the boundary between the distal end portion 40 and the second inclined surface 42 comes into contact with and slides on the second guide surface 105b of the wall surface groove portion 105. Accordingly, the positioning projection portion 33 is inserted toward the wall surface groove portion 105. As a result, as illustrated in FIG. 7, the connector 1 has no inclination with respect to the fixed wall surface 102 and faces the mating connector 110.

The operator further tightens the fastening bolt 50 to fit the fitting portion 11A to the mating connector 110 and connect the connector terminal 3 to the mating terminal 111 of the mating connector 110 (FIG. 5).

In the conventional connector, in a case where the fastening bolt 50 is inserted into and screwed into the fastening hole 104 in a state where the fastening bolt 50 is inserted into the through hole 23, there is a risk that the connector does not face the fixed wall surface 102 in the insertion and removal direction X. In the case of fixing the connector with one fastening bolt 50, for example, as illustrated in FIG. 6, the entire connector tends to tilt in the direction intersecting the insertion and removal direction X due to the size of a gap between the shaft portion 52 and the through hole 23 due to a relationship between the intersection of the outer diameter of the shaft portion 52 and the intersection of the inner diameter of the through hole 23. When the fastening bolt 50 is further tightened in a state where the connector 1 does not face the fixed wall surface 102 in the insertion and removal direction X, there is a possibility that the entire connector 1 is fitted to the mating connector 110 in an inclined state. In this case, there is a risk that the connector terminal 3 comes into contact with the mating terminal 111 in an inclined state, and distortion occurs between the terminals. Therefore, the worker can perform the fitting operation while holding the connector 1 so as to face the fixed wall surface 102 in the insertion and removal direction X, but there is a risk that it takes time and effort for the assembly operation.

As described above, the connector 1 according to the present embodiment includes the housing member 10 having the fitting portion 11A to be fitted to the mating connector 110, and the fixing member 20 fixed to the fixed wall surface 102 together with the housing member 10. The fixing member 20 has the through hole 23 of the fastening bolt 50 that is fastened to the fastening hole 104 of the fixed wall surface 102 to fix the fixing member 20 to the fixed wall surface 102 together with the housing member 10. The housing member 10 is positioned on the opposite side of the through hole 23 provided in the fixing member 20 with the fitting portion 11A interposed therebetween with respect to the vertical direction Z, and has the positioning projection portion 33 formed to protrude toward the fixed wall surface 102 in the fitted state. The positioning projection portion 33 is inserted into the wall surface groove portion 105 formed in the fixed wall surface 102 along the insertion and removal direction X in the fitted state.

With the above configuration, when the connector 1 is fixed to the fixed wall surface 102 by fastening the fastening bolt 50 and fitting the connector 1 to the mating connector 110, the positioning projection portion 33 is inserted toward the wall surface groove portion 105. As a result, the connector 1 can correct the inclination of the connector 1 with respect to the mating connector 110, and the connector terminal 3 in the fitting portion 11A can face the mating terminal 111 in the mating connector 110 in the insertion and removal direction X. As a result, the connector 1 can suppress twisting between the connector terminal 3 and the mating terminal 111, and can be appropriately fitted to the mating connector.

In the connector 1 according to the present embodiment, the housing member 10 includes the housing 11 made of resin, and the positioning projection portion 33 is integrally formed with the housing 11. Thus, in the connector 1, since the housing 11 is made of resin, it is easy to form the positioning projection portion 33 with respect to the housing 11.

In the above embodiment, the positioning projection portion 33 has a rectangular cross-sectional shape when viewed from the insertion and removal direction X, but the present invention is not limited thereto. The positioning projection portion 33 may have a circular or elliptical cross-sectional shape as viewed from the insertion and removal direction X, or may have a triangular or pentagonal or more polygonal cross-sectional shape.

In the above embodiment, the positioning projection portion 33 is provided in the housing 11, but is not limited thereto, and may be provided in the shell body 21 as a shield shell.

In the above embodiment, the positioning projection portion 33 is provided at one position with respect to the connector 1, but the present invention is not limited thereto, and the positioning projection portions may be provided at a plurality of positions. In this case, the wall surface groove portions 105 provided on the fixed wall surface 102 may be provided at a plurality of locations according to the positions of the positioning projection portions 33. In a case where the plurality of positioning projection portions 33 is arranged at regular intervals along the width direction Y, the wall surface groove portion 105 may be one groove formed to extend in the width direction Y so that the plurality of positioning projection portions 33 can be simultaneously inserted.

In the above embodiment, the positioning projection portion 33 is positioned on a virtual line passing through a center of the through hole 23 and a center of the connector insertion hole 103 as viewed in the insertion and removal direction X along the vertical direction Z in the fitted state, but the present invention is not limited thereto. That is, the positioning projection portion 33 may be provided at a position offset from the virtual line. In this case, the positioning projection portion 33 is preferably provided on the downward direction Z2 side from the connector insertion hole 103.

In the above embodiment, in the connector 1, the wiring members W are pulled out toward the downward direction Z2 side, but the present invention is not limited thereto. For example, in the connector 1, the wiring members W may be pulled out toward at least one side in the width direction Y, or may be pulled out toward the removal direction X2 side.

According to the connector of the present embodiment, there is an effect that the connector can be appropriately fitted to the mating connector.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing member that accommodates a terminal and has a fitting portion to be fitted with a mating connector provided on a connection target; and
a fixing member fixed to a fixed wall surface of the connection target together with the housing member in a fitted state in which the fitting portion is fitted to the mating connector,
wherein the fixing member includes
a through hole through which a fastening bolt communicating with a fastening hole formed in the fixed wall surface along a fitting direction of the fitting portion with respect to the mating connector in the fitted state and fastened to the fastening hole is inserted into the fixing member along the fitting direction,
one of the housing member and the fixing member includes
a positioning projection portion positioned on an opposite side of the through hole across the fitting portion with respect to an intersecting direction intersecting the fitting direction and formed to project toward a side of the fixed wall surface in the fitted state, and
the positioning projection portion is
inserted into a groove portion formed in the fixed wall surface along the fitting direction in the fitted state.

2. The connector according to claim 1, wherein
the housing member includes
a housing made of resin,
the fixing member includes
a metallic shield shell covering an outer side of the housing,
the through hole is
formed integrally with the shield shell, and
the positioning projection portion is
formed integrally with the housing.
